(19) United States
(12) Patent Application Publication
(10) Pub. No.: US 2016/0335242 A1
(43) Pub. Date: Nov. 17, 2016

(54) System and Method of Communicating between Interactive Systems

(71) Applicant: SMART Technologies ULC, Calgary (CA)

(72) Inventors: Chung Chi CHENG, Calgary (CA); Michael BOYLE, Calgary (CA)

(21) Appl. No.: 15/004,723

(22) Filed: Jan. 22, 2016

Related U.S. Application Data
(63) Continuation of application No. 14/721,899, filed on May 26, 2015.
Application No. 14/721,899 is a continuation-in-part of application No. 14/712,452, filed on May 14, 2015.

(51) Int. Cl. G06F 17/24; G06F 3/14; G06F 3/0488; G06F 17/27; G06F 3/0484

(52) U.S. Cl. CPC G06F 17/248; G06F 17/2765; G06F 3/04842; G06F 3/04845; G06F 3/04883; G06F 3/1415

(57) ABSTRACT

The present invention relates to a method and system for identifying templates or forms for interpreting data input thereto on an interactive device in communication with one or more mobile devices. The interactive device comprises template overlay, having an identifiable feature, is aligned with an interactive surface. The mobile device has a reader that reads the identifiable feature and produces a template identifier that is retrieved from a content server. Input into the template overlay is recognized and interpreted into labels or equations. Subsequent input is then automatically calculated using the equation.

### RELATED APPLICATIONS

This application is a continuation-in-part of U.S. patent application Ser. No. 14/721,899 filed May 26, 2015, hereby incorporated by reference, and this application is a continuation-in-part of U.S. patent application Ser. No. 14/712,452, filed May 15, 2015, hereby incorporated by reference.

### FIELD OF THE INVENTION

The present invention relates generally to providing template or form input to an interactive input system. More particularly, the present invention relates to a method and system for identifying templates or forms for interpreting data input thereto.

### BACKGROUND OF THE INVENTION

With the increased popularity of distributed computing environments and smart phones, it is becoming increasingly unnecessary to carry multiple devices. A single device can provide access to all of a user's information, content, and software. Software platforms can now be provided as a service remotely through the Internet. User data and profiles are now stored in the “cloud” using services such as Facebook®, Google Cloud storage, Dropbox®, Microsoft OneDrive®, or other services known in the art. One problem encountered with smart phone technology is that users frequently do not want to work primarily on their smart phone due to their relatively small screen size and/or user interface.

Conferencing systems that allow participants to collaborate from different locations, such as for example, SMART Bridgit™, Microsoft® Live Meeting, Microsoft® Lync, Skype™, Cisco® MeetingPlace, Cisco® WebEx, etc., are well known. These conferencing systems allow meeting participants to exchange voice, audio, video, computer display screen images and/or files. Some conferencing systems also provide tools to allow participants to collaborate on the same topic by sharing content, such as for example, display screen images or files amongst participants. In some cases, annotation tools are provided that allow participants to modify shared display screen images and then distribute the modified display screen images to other participants.

Prior methods for connecting smart phones, with somewhat limited user interfaces, to conferencing systems or more suitable interactive input devices such as interactive whiteboards, displays such as high-definition televisions (HDTVs), projectors, conventional keyboards, etc. have been unable to provide a seamless experience for users. In addition, the prior methods have difficulty adapting communication protocols to meet different mobile device requirements.

For example, SMART Bridgit™ offered by SMART Technologies ULC of Calgary, Alberta, Canada, assignee of the subject application, allows a user to set up a conference having an assigned conference name and password at a server. Conference participants at different locations may join the conference by providing the correct conference name and password to the server. During the conference, voice and video connections are established between participants via the server. A participant may share one or more computer display screen images so that the display screen images are distributed to all participants. Pen tools and an eraser tool can be used to annotate on shared display screen images, e.g., inject ink annotation onto shared display screen images or erase one or more segments of ink from shared display screen images. The annotations made on the shared display screen images are then distributed to all participants.

U.S. Pat. No. 4,763,356 to Day, herein incorporated by reference, discloses a personal computer connected to a display and touch screen panel with a form entry system integrated therewith. The form entry system is adapted to display a predefined form and to automatically display a predefined tool, such as a keyboard, menu, calculator, etc., to facilitate inputting information in a respective field of the form or chart. Specifically, the user is prompted as to which field is to be filled in by highlighting the field and concurrently displaying as an overlay (window) the tool that the user will use to input the information called for by the highlighted field. In the case where a field calls for illustratively the insertion of a name, the system may be adapted to display a menu of names as the tool for filling in that field. The user selects the name that he or she desired to be inserted in the field by touching that name. The system responsive thereto inserts the name in that field, highlights the next field to be filled in and displays the tool for filling that field. The system may also be adapted to communicate with a host computer to obtain the information that is to be inserted in one or more fields. Also, the user may erase the tool that is displayed by the system and direct the system to display another tool, such as the aforementioned keyboard.

U.S. Pat. No. 6,282,315 to Boyer, herein incorporated by reference, discloses a method for entering data into a computer generated form including field areas of preselected height and width includes the steps of converting handwritten characters of arbitrary height which may be greater than the preselected height formed on the screen to computer generated characters and displaying the computer generated characters within a field area. Additionally, handwritten characters to be entered into several field areas are grouped, converted, and displayed in selected field areas.

U.S. Publication No. 2012/0144283 to SMART Technologies ULC, assignee of the subject application, the entire disclosure of which is incorporated by reference, discloses a conferencing system having a plurality of computing devices communicating over a network during a conference session. The computing devices are configured to share content displayed with other computing devices. Each computing device in the conference session supports two input modes namely, an annotation mode and a cursor mode depending on the status of the input devices connected thereto. When a computing device is in the annotation mode, the annotation engine overlies the display screen image with a transparent annotation layer to annotate digital ink over the display. When cursor mode is activated, an input device may be used to select digital objects or control the execution of application programs.

The invention described herein at least provides a system and method of template generation, application, and interpretation for an interactive input system and/or mobile device.

### SUMMARY OF THE INVENTION

According to one aspect of the invention, there is provided a mobile device comprising: a processing structure; a reader coupled to the processing structure; a network communicating with the processing structure and a content server; and a computer-readable medium coupled to the processing structure, the computer-readable medium comprising instructions to configure the processing structure. The instructions may scan, using the reader, an identifiable feature of a template overlay; interpret the identifiable feature to produce a template identifier; request template overlay instructions associated with the template identifier from the content server; receive the template overlay instructions from the content server over the network. Upon receiving input from an interactive device into an area of the template overlay displayed over an input surface of the interactive device: recognizing, via text recognition, the input into the area to identify at least one digitized input data; identifying as subset of the template overlay instructions associated with the area; and automatically executing the identified template overlay instructions.

The template overlay instructions may define label regions of the template overlay; upon receiving input from the interactive device within the label regions, recognizing, via text recognition, at least one label. The template overlay instructions may associate the area with at least one equation; the at least one equation using at least one of the labels.

According to another aspect of the invention, the mobile device may further comprise local network communicating with the processing structure and an interactive device; and instructions to configure the processing structure to: prompt a user to contact the template overlay on at least two calibration points; and align the template overlay with a virtual template.

According to any aspect of the invention, the reader may comprise a camera, or a near-field communication scanner.

According to yet another aspect of the invention, the mobile device may further comprising instructions to configure the processing structure to:receive a set of rows following receiving the at least one equation; and automatically executing the equation on labeled input entered into the set of rows.

According to other aspects of the invention, the labeled input may be aligned in a column underneath the at least one label. The modification of the at least one equation may initiates re-executing the equation on the labeled input.

According to another aspect of the invention, there is provided an interactive device comprising: a processing structure; an interactive surface; a template overlay generally aligned with the interactive surface; an identifiable feature associated with the template overlay; a transceiver communicating with a mobile device over a network using a communication protocol; and a computer-readable medium, coupled to the processing structure, comprising instructions to configure the processing structure to: determine a location of a pointer on the interactive surface; and transmitting the location of the pointer to the mobile device over the network.

The identifiable feature may comprise a 2-D barcode or a NFC tag.

According to any aspect of the invention, the template overlay may be selected from at least one of a virtual overlay or a physical overlay.

### BRIEF DESCRIPTION OF THE DRAWINGS

An embodiment will now be described, by way of example only, with reference to the attached Figures, wherein:

FIG. 1 shows an overview of collaborative devices in communication with one or more portable devices and servers;

FIGS. 2A and 2B show a perspective view of a capture board and control icons respectively;

FIG. 2C shows an example of a template overlay configured to be attached to the capture board;

FIGS. 3A to 3C demonstrate a processing architecture of the capture board;

FIG. 4A to 4D show a touch detection system of the capture board;

FIG. 5 demonstrates a processing structure of a mobile device;

FIG. 6 shows a processing structure of one of more servers;

FIGS. 7A and 7B demonstrate an overview of processing structure and protocol stack of a communication system; and

FIGS. 8A and 8B show a flowchart of a mobile device configured to execute a dedicated application thereon.

### DETAILED DESCRIPTION OF THE EMBODIMENT

While the Background of Invention described above has identified particular problems known in the art, the present invention provides, in part, a new and useful application adapting communication between interactive systems.

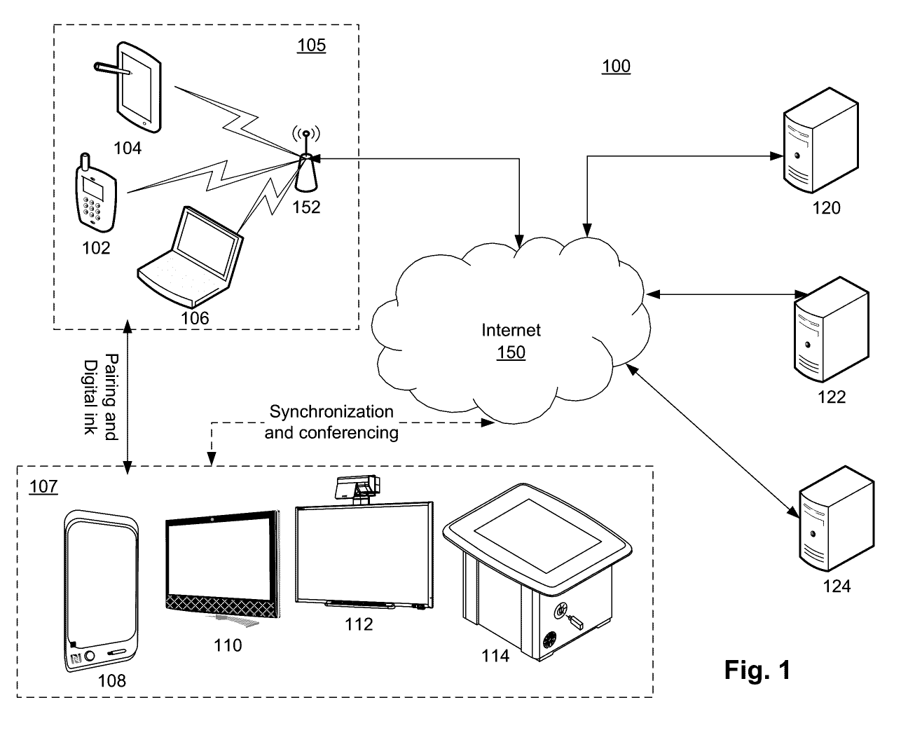

FIG. 1 demonstrates a high-level hardware architecture 100 of the present embodiment. A user has a mobile device 105 such as a smartphone 102, a tablet computer 104, or laptop 106 that is in communication with a wireless access point 152 such as 3G, LTE, WiFi, Bluetooth®, near-field communication (NFC) or other proprietary or non-proprietary wireless communication channels known in the art. The wireless access point 152 allows the mobile devices 105 to communicate with other computing devices over the Internet 150. In addition to the mobile devices 105, a plurality of collaborative devices 107 such as a kapp™ capture board 108 produced by SMART Technologies, wherein the User's Guide is herein incorporated by reference, an interactive flat screen display 110, an interactive whiteboard 112, or an interactive table 114 may also connected to the Internet 150. The system comprises an authentication server 120, a profile or session server 122, and a content server 124. The authentication server 120 verifies a user login and password or other type of login such as using encryption keys, one time passwords, etc. The profile server 122 saves information about the user logged into the system. The content server 124 comprises three levels: a persistent back-end database, middleware for logic and synchronization, and a web application server. The mobile devices 105 may be paired with the capture board 108 as will be described in more detail below. The capture board 108 may also provide synchronization and conferencing capabilities over the Internet 150 as will also be further described below.

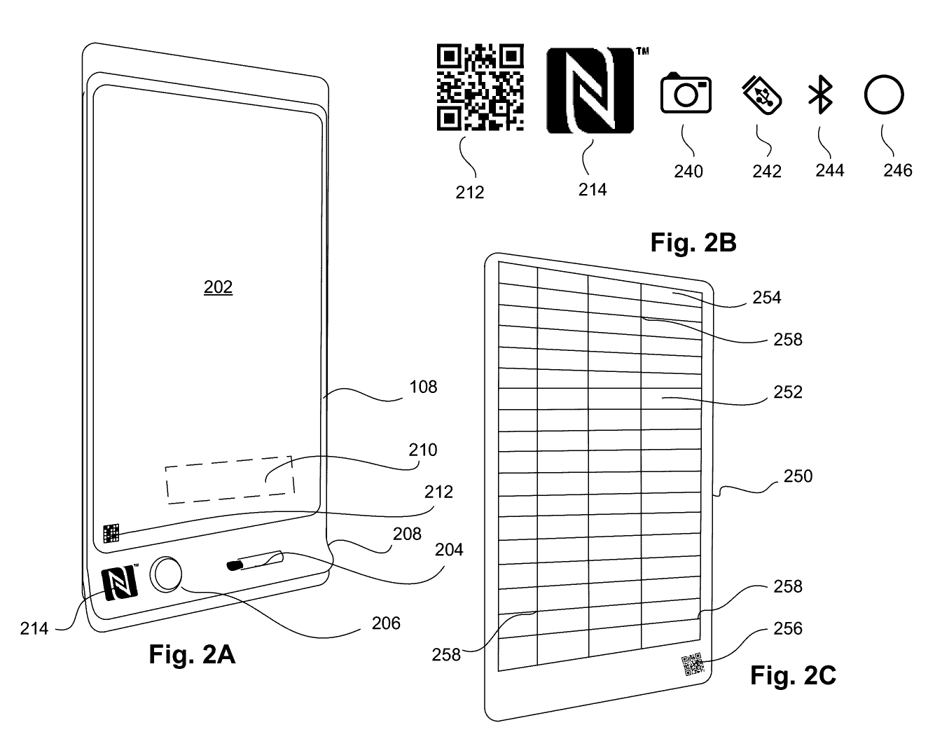

As shown in FIG. 2A, the capture board 108 comprises a generally rectangular touch area 202 whereupon a user may draw using a dry erase marker or pointer 204 and erase using an eraser 206. The capture board 108 may be in a portrait or landscape configuration and may be a variety of aspect ratios. The capture board 108 may be mounted to a vertical support surface such as for example, a wall surface or the like or optionally mounted to a moveable or stationary stand. Optionally, the touch area 202 may also have a display 318 for presenting information digitally and the marker 204 and eraser 206 produces virtual ink on the display 318. The touch area 202 comprises a touch sensing technology capable of determining and recording the pointer 204 (or eraser 206) position within the touch area 202. The recording of the path of the pointer 204 (or eraser) permits the capture board to have an digital representation of all annotations stored in memory as described in more detail below.

The capture board 108 comprises at least one of a quick response (QR) code 212 and/or a near-field communication (NFC) area 214 of which may be used to pair the mobile device 105 to the capture board 108. The QR code 212 is a two-dimensional bar code that may be uniquely associated with the capture board 108. In this embodiment, the QR Code 212 comprises a pairing Universal Resource Locator (URL) derived from the Bluetooth address of the board. The NFC area 214 comprises a loop antenna (not shown) that interfaces by electromagnetic induction to a second loop antenna 340 located within the mobile device 105. Similar as for the QR code 212, the NFC tag 214 stores the pairing URL produced in a similar manner as for the QR code 212.

As shown in FIG. 2B, an elongate icon control bar 210 may be present adjacent the bottom of the touch area 202 or on the tool tray 208 and this icon control bar may also incorporate the QR code 212 and/or the NFC area 214. All or a portion of the control icons within the icon control bar 210 may be selectively illuminated (in one or more colours) or otherwise highlighted when activated by user interaction or system state. Alternatively, all or a portion of the icons may be completely hidden from view until placed in an active state. The icon control bar 210 may comprise a capture icon 240, a universal serial bus (USB) device connection icon 242, a Bluetooth/WiFi icon 244, and a system status icon 246 as will be further described below. Alternatively, if the capture board 108 has a display 318, then the icon control bar 210 may be digitally displayed on the display 318 and may optionally overlay the other displayed content on the display 318.

FIG. 2C further shows an example of a template overlay 250 configured to be attached to the touch area 202 of the capture board 108. The template overlay 250 may be affixed to the touch area 202 using permanent or non-permanent adhesives, electrostatic attraction, magnets located in the template overlay 250 attracted to corresponding metal or magnets within the capture board 108. Alternatively the template overlay 250 may be inserted behind an outer glass sheet covering the touch area 202, or permanently affixed behind the transparent touch area 202. The template overlay 250 in this example shows a table configuration having a header row 254 having four columns and a series of rows 252 below. The columns and row lines are permanently affixed or built into the template overlay 250. Other templates 250 may be possible with different numbers of rows or columns, or the template 250 may comprise areas defined as fields for input. Other templates 250 may comprise areas where the user may sketch drawings while other areas are for writing text. Yet another alternatively, the templates may have cutouts so that only guides such as the gridlines in FIG. 2C are presented by the template, and the user enters data by writing on the touch area 202 of the capture board 108 directly. Each template 250 comprises an identifiable feature 256 such as a quick response (QR) code or NFC tag enabling identification of the template 250 to the mobile device 105. Alternatively, the identifiable feature 256 may comprise the entire template overlay 256. During installation or changing of the template 250, the touch area 202 may be locked from accepting input. The template 250 may be aligned with the touch area 202 using a set of markers (not shown) present on the touch area 202 or may be aligned with the edges and corners of the touch area 202.

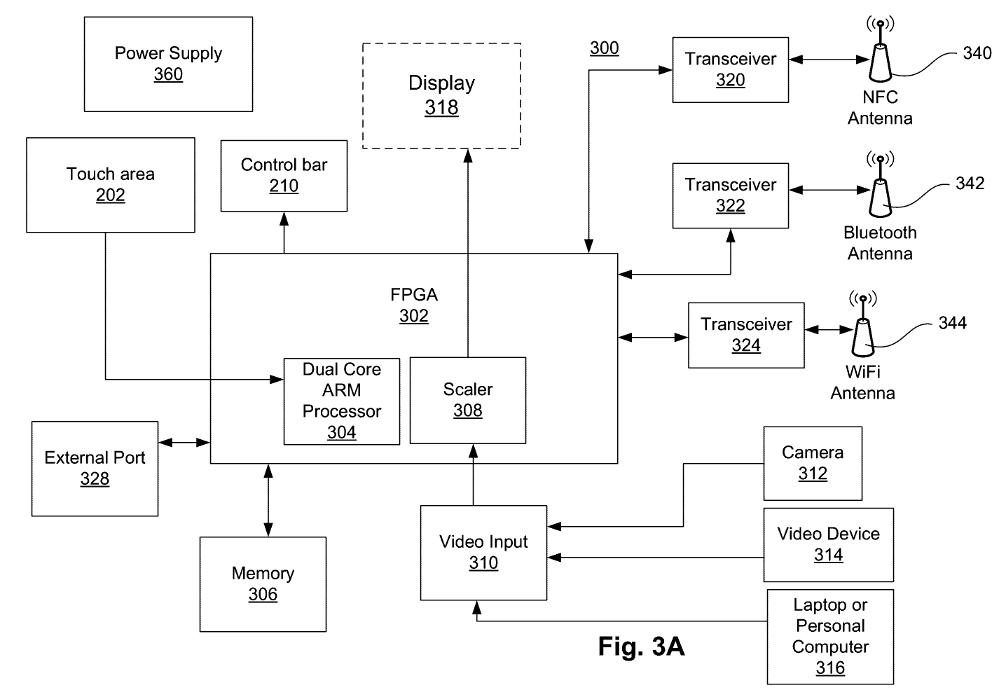

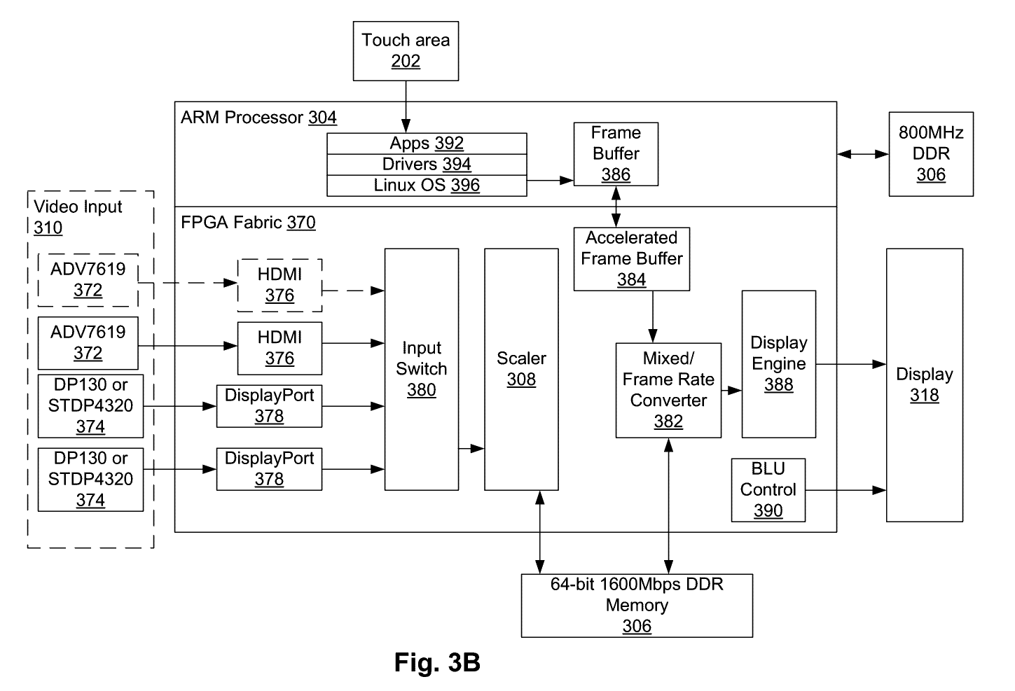

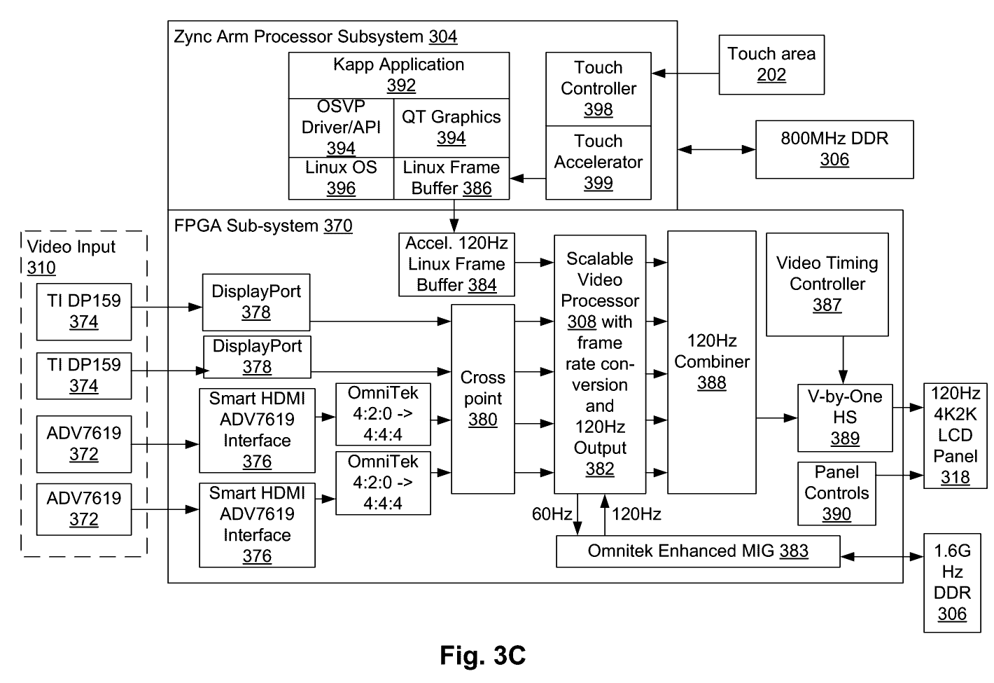

Turning to FIGS. 3A to 3C, the capture board 108 may be controlled with an field programmable gate array (FPGA) 302 or other processing structure which in this embodiment, comprises a dual core ARM Processor 304 executing instructions from volatile or non-volatile memory 306 and storing data thereto. The FPGA 302 may also comprises a scaler 308 which scales video inputs 310 to a format suitable for presenting on a display 318. The display 318 generally corresponds in approximate size and approximate shape to the touch area 202. The display 318 is typically a large-sized display for either presentation or collaboration with group of users. The resolution is sufficiently high to ensure readability of the display 318 by all participants. The video input 310 may be from a camera 312, a video device 314 such as a DVD player, Blu Ray player, VCR, etc, or a laptop or personal computer 316. The FPGA 302 communicates with the mobile device 105 (or other devices) using one or more transceivers such as, in this embodiment, an NFC transceiver 320 and antenna 340, a Bluetooth transceiver 322 and antenna 342, or a WiFi transceiver 324 and antenna 344. Optionally, the transceivers and antennas may be incorporated into a single transceiver and antenna. The FPGA 302 may also communicate with an external device 328 such as a USB memory storage device (not shown) where data may be stored thereto. A wired power supply 360 provides power to all the electronic components 300 of the capture board 108. The FPGA 302 interfaces with the previously mentioned icon control bar 210.

When the user contacts the pointer 204 with the touch area 202, the processor 304 tracks the motion of the pointer 204 and stores the pointer contacts in memory 306.

Alternatively, the touch points may be stored as motion vectors or Bezier splines. The memory 306 therefore contains a digital representation of the drawn content within the touch area 202. Likewise, when the user contact the eraser 206 with the touch area 202, the processor 304 tracks the motion of the eraser 206 and removes drawn content from the digital representation of the drawn content. In this embodiment, the digital representation of the drawn content is stored in non-volatile memory 306.

When the pointer 204 contacts the touch area 202 in the location of the capture (or snapshot) icon 240, the FPGA 302 detects this contact as a control function which initiates the processor 304 to copy the currently stored digital representation of the drawn content to another location in memory 306 as a new page also known as a snapshot. The capture icon 240 may optionally flash during the saving of the digital representation of drawn content to another memory location. The FPGA 302 then initiates a snapshot message to one or more of the paired mobile device(s) 105 via the appropriately paired transceiver(s) 320, 322, and/or 324. The message contains an indication to the paired mobile device(s) 105 to capture the current image as a new page. Optionally, the message may also contain any changes that were made to the page after the last update sent to the mobile device(s) 105. The user may then continue to annotate or add content objects within the touch area 202. Optionally, once the transfer of the page to the paired mobile device 105 is complete, the page may be deleted from memory 306.

If a USB memory device (not shown) is connected to the external port 328, the FPGA 302 illuminates the USB device connection icon 242 in order to indicate to the user that the USB memory device is available to save the captured pages. When the user contacts the capture icon 240 with the pointer 204 and the USB memory device is present, the captured pages are transferred to the USB memory device as well as being transferred to any paired mobile device 105. The captured pages may be converted into another file format such as PDF, Evernote, XML, Microsoft Word®, Microsoft® Visio, Microsoft® Powerpoint, etc and if the file has previously been saved on the USB memory device, then the pages since the last save may be appended to the previously saved file. During a save to the USB memory, the USB device connection icon 242 may flash to indicate a save is in progress.

If the user contacts the USB device connection icon 242 using the pointer 204 and the USB memory device is present, the FPGA 302 flushes any data caches to the USB memory device and disconnects the USB memory device in the conventional manner. If an error is encountered with the USB memory device, the FPGA 302 may cause the USB device connection icon 242 to flash red. Possible errors may be the USB memory device being formatted in an incompatible format, communication error, or other type of hardware failure.

When one or more mobile devices 105 begins pairing with the capture board 108, the FPGA 302 causes the Bluetooth icon 244 to flash. Following connection, the FPGA 302 causes the Bluetooth icon 244 to remain active. When the pointer 204 contacts the Bluetooth icon 244, the FPGA 302 may disconnect all the paired mobile devices 105 or may disconnect the last connected mobile device 105. Optionally for capture boards 108 with a display 318, the FPGA 302 may display an onscreen menu on the display 318 prompting the user to select which mobile device 105 (or remotely connected device) to disconnect. When the mobile device 105 is disconnecting from the capture board 108, the Bluetooth icon 244 may flash red in colour. If all mobile devices 105 are disconnected, the Bluetooth icon 244 may be solid red or may not be illuminated.

When the FPGA 302 is powered and the capture board 108 is working properly, the FPGA 302 causes the system status icon 246 to become illuminated. If the FPGA 302 determines that one of the subsystems of the capture board 108 is not operational or is reporting an error, the FPGA 302 causes the system status icon 246 to flash. When the capture board 108 is not receiving power, all of the icons in the control bar 210 are not illuminated.

FIGS. 3B and 3C demonstrate examples of structures and interfaces of the FPGA 302. As previously mentioned, the FPGA 302 has an ARM Processor 304 embedded within it. The FPGA 302 also implements an FPGA Fabric or Sub-System 370 which, in this embodiment comprises mainly video scaling and processing. The video input 310 comprises receiving either High-Definition Multimedia Interface (HDMI) or DisplayPort, developed by the Video Electronics Standards Association (VESA), via one or more Xpressview 3 GHz HDMI receivers (ADV7619) 372 produced by Analog Devices, the Data Sheet and User Guide herein incorporated by reference, or one or more DisplayPort Re-driver (DP130 or DP159) 374 produced by Texas Instruments, the Data Sheet, Application Notes, User Guides, and Selection and Solution Guides herein incorporated by reference. These HDMI receivers 372 and DisplayPort re-drivers 374 interface with the FPGA 302 using corresponding circuitry implementing Smart HDMI Interfaces 376 and DisplayPort Interfaces 378 respectively. An input switch 380 detects and automatically selects the currently active video input. The input switch or crosspoint 380 passes the video signal to the scaler 308 which resizes the video to appropriately match the resolution of the currently connected display 318. Once the video is scaled, it is stored in memory 306 where it is retrieved by the mixed/frame rate converter 382.

The ARM Processor 304 has applications or services 392 executing thereon which interface with drivers 394 and the Linux Operating System 396. The Linux Operating System 396, drivers 394, and services 392 may initialize wireless stack libraries. For example, the protocols of the Bluetooth Standard, the Adopted Bluetooth Core Specification v 4.2 Master Table of Contents & Compliance Requirements herein incorporated by reference, may be initiated such as an radio frequency communication (RFCOMM) server, configure Service Discovery Protocol (SDP) records, configure a Generic Attribute Profile (GATT) server, manage network connections, reorder packets, transmit acknowledgements, in addition to the other functions described herein. The applications 392 alter the frame buffer 386 based on annotations entered by the user within the touch area 202.

A mixed/frame rate converter 382 overlays content generated by the Frame Buffer 386 and Accelerated Frame Buffer 384. The Frame Buffer 386 receives annotations and/or content objects from the touch controller 398. The Frame Buffer 386 transfers the annotation (or content object) data to be combined with the existing data in the Accelerated Frame Buffer 384. The converted video is then passed from the frame rate converter 382 to the display engine 388 which adjusts the pixels of the display 318.

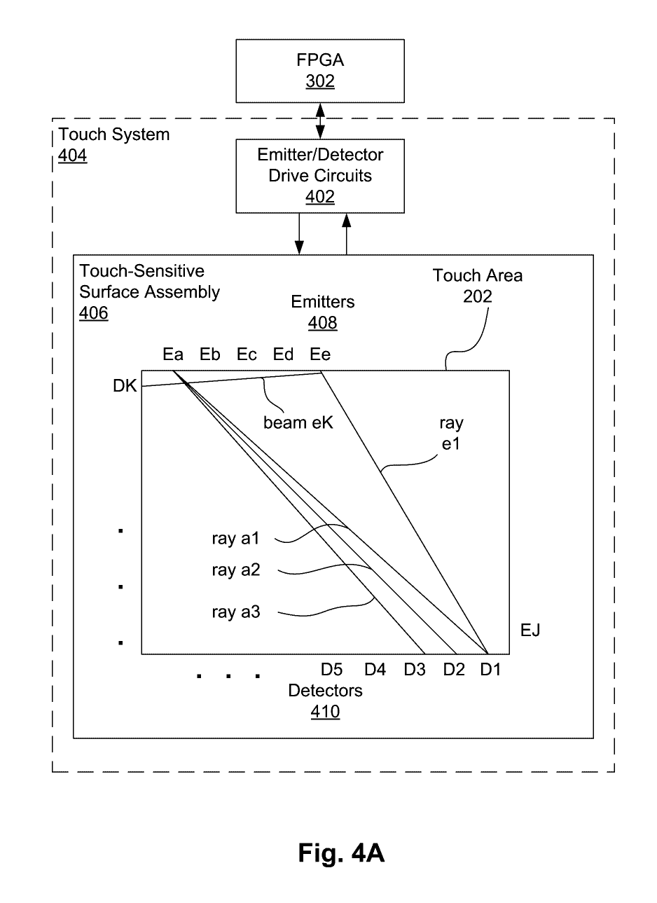

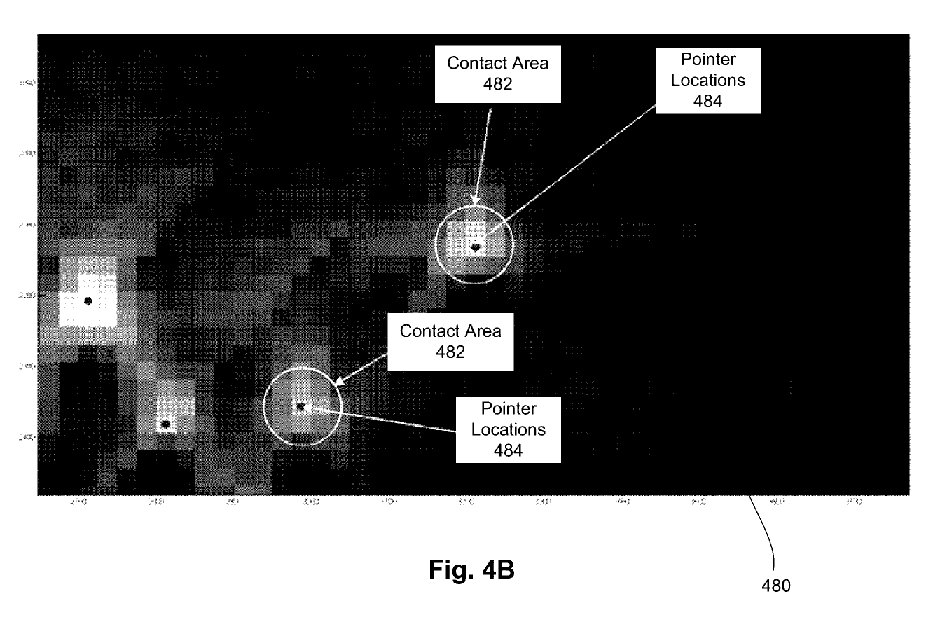

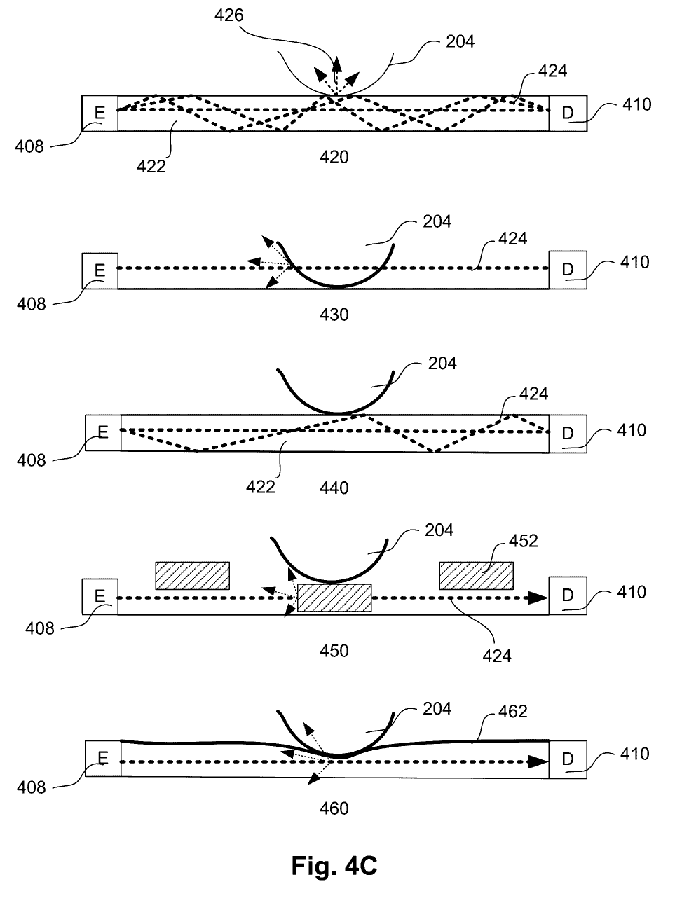

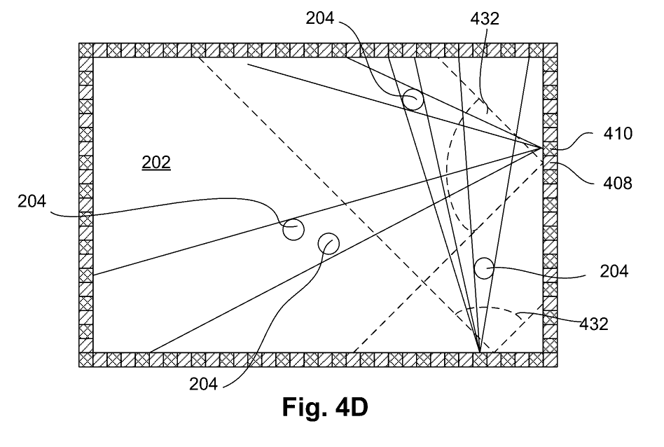

In FIG. 3C, a OmniTek Scalable Video Processing Suite, produced by OmniTek of the United Kingdom, the OSVP 2.0 Suite User Guide June 2014 herein incorporated by reference, is implemented. The scaler 308 and frame rate converter 382 are combined into a single processing block where each of the video inputs are processed independently and then combined using a 120 Hz Combiner 388. The scaler 308 may perform at least one of the following on the video: chroma upsampling, colour correction, deinterlacing, noise reduction, cropping, resizing, and/or any combination thereof. The scaled and combined video signal is then transmitted to the display 318 using a V-by-One HS interface 389 which is an electrical digital signaling standard that can run at up to 3.75 Gbit/s for each pair of conductors using a video timing controller 387. An additional feature of the embodiment shown in FIG. 3C is an enhanced Memory Interface Generator (MIG) 383 which optimizes memory bandwidth with the FPGA 302. The touch area 202 provides either transmittance coefficients to a touch controller 398 or may optionally provide raw electrical signals or images. The touch controller 398 then processes the transmittance coefficients to determine touch locations as further described below with reference to FIG. 4A to 4C. The touch accelerator 399 determines which pointer 204 is annotating or adding content objects and injects the annotations or content objects directly into the Linux Frame buffer 386 using the appropriate ink attributes.

The FPGA 302 may also contain backlight control unit (BLU) or panel control circuitry 390 which controls various aspects of the display 318 such as backlight, power switch, on-screen displays, etc.

The touch area 202 of the embodiment of the invention is observed with reference to FIGS. 4A to 4D and further disclosed in U.S. Pat. No. 8,723,840 to Rapt Touch, Inc. and Rapt IP Ltd respectively, the contents thereof incorporated by reference in their entirety. The FPGA 302 interfaces and controls the touch system 404 comprising emitter/detector drive circuits 402 and a touch-sensitive surface assembly 406. As previously mentioned, the touch area 202 is the surface on which touch events are to be detected. The surface assembly 406 includes emitters 408 and detectors 410 arranged around the periphery of the touch area 202. In this example, there are K detectors identified as D1 to DK and J emitters identified as Ea to EJ. The emitter/detector drive circuits 402 provide an interface between the FPGA 302 whereby the FPGA 302 is able to independently control and power the emitters 408 and detectors 410. The emitters 408 produce a fan of illumination generally in the infrared (IR) band whereby the light produced by one emitter 408 may be received by more than one detector 410. A “ray of light” refers to the light path from one emitter to one detector irrespective of the fan of illumination being received at other detectors. The ray from emitter Ej to detector Dk is referred to as ray jk. In the present example, rays a1, a2, a3, e1 and eK are examples.

When the pointer 204 contact the touch area 202, the fan of light produced by the emitter(s) 408 is disturbed thus changing the intensity of the ray of light received at each of the detectors 410. The FPGA 302 calculates a transmission coefficient Tjk for each ray in order to determine the location and times of contacts with the touch area 202. The transmission coefficient Tjk is the transmittance of the ray from the emitter j to the detector k in comparison to a baseline transmittance for the ray. The baseline transmittance for the ray is the transmittance measured when there is no pointer 204 interacting with the touch area 202. The baseline transmittance may be based on the average of previously recorded transmittance measurements or may be a threshold of transmittance measurements determined during a calibration phase. The inventor also contemplates that other measures may be used in place of transmittance such as absorption, attenuation, reflection, scattering, or intensity.

The FPGA 302 then processes the transmittance coefficients Tjk from a plurality of rays and determines touch regions corresponding to one or more pointers 204. Optionally, the FPGA 302 may also calculate one or more physical attributes such as contact pressure, pressure gradients, spatial pressure distributions, pointer type, pointer size, pointer shape, determination of glyph or icon or other identifiable pattern on pointer, etc.

Based on the transmittance coefficients Tjk for each of the rays, a transmittance map is generated by the FPGA 302 such as shown in FIG. 4B. The transmittance map 480 is a grayscale image whereby each pixel in the grayscale image represents a different “binding value” and in this embodiment each pixel has a width and breadth of 2.5 mm. Contact areas 482 are represented as white areas and non-contact areas are represented as dark gray or black areas. The contact areas 482 are determined using various machine vision techniques such as, for example, pattern recognition, filtering, or peak finding. The pointer locations 484 are determined using a method such as peak finding where one or more maximums is detected in the 2D transmittance map within the contact areas 482. Once the pointer locations 484 are known in the transmittance map 480, these locations 484 may be triangulated and referenced to locations on the display 318 (if present). Methods for determining these contact locations 484 are disclosed in U.S. Patent Publication No. 2014/0152624, herein incorporated by reference.

Five example configurations for the touch area 202 are presented in FIG. 4C. Configurations 420 to 440 are configurations whereby the pointer 204 interacts directly with the illumination being generated by the emitters 408. Configurations 450 and 460 are configurations whereby the pointer 204 interacts with an intermediate structure in order to influence the emitted light rays.

A frustrated total internal reflection (FTIR) configuration 420 has the emitters 408 and detectors 410 optically mated to an optically transparent waveguide 422 made of glass or plastic. The light rays 424 enter the waveguide 422 and is confined to the waveguide 422 by total internal reflection (TIR). The pointer 204 having a higher refractive index than air comes into contact with the waveguide 422. The increase in the refractive index at the contact area 482 causes the light to leak 426 from the waveguide 422. The light loss attenuates rays 424 passing through the contact area 482 resulting in less light intensity received at the detectors 410.

A beam blockage configuration 430, further shown in more detail with respect to FIG. 4D, has emitters 408 providing illumination over the touch area 202 to be received at detectors 410 receiving illumination passing over the touch area 202. The emitter(s) 408 has an illumination field 432 of approximately 90-degrees that illuminates a plurality of pointers 204. The pointer 204 enters the area above the touch area 202 whereby it partially or entirely blocks the rays 424 passing through the contact area 482. The detectors 410 similarly have an approximately 90-degree field of view and receive illumination either from the emitters 408 opposite thereto or receive reflected illumination from the pointers 204 in the case of a reflective or retro-reflective pointer 204. The emitters 408 are illuminated one at a time or a few at a time and measurements are taken at each of the receivers to generate a similar transmittance map as shown in FIG. 4B.

Another total internal reflection (TIR) configuration 440 is based on propagation angle. The ray is guided in the waveguide 422 via TIR where the ray hits the waveguide-air interface at a certain angle and is reflected back at the same angle. Pointer 204 contact with the waveguide 422 steepens the propagation angle for rays passing through the contact area 482. The detector 410 receives a response that varies as a function of the angle of propagation.

The configuration 450 show an example of using an intermediate structure 452 to block or attenuate the light passing through the contact area 482. When the pointer 204 contacts the intermediate structure 452, the intermediate structure 452 moves into the touch area 202 causing the structure 452 to partially or entirely block the rays passing through the contact area 482. In another alternative, the pointer 204 may pull the intermediate structure 452 by way of magnetic force towards the pointer 204 causing the light to be blocked.

In an alternative configuration 460, the intermediate structure 452 may be a continuous structure 462 rather than the discrete structure 452 shown for configuration 450. The intermediate structure 452 is a compressible sheet 462 that when contacted by the pointer 204 causes the sheet 462 to deform into the path of the light. Any rays 424 passing through the contact area 482 are attenuated based on the optical attributes of the sheet 462. In embodiments where a display 318 is present, the sheet 462 is transparent. Other alternative configurations for the touch system are described in U.S. patent application Ser. No. 14/452,882 and U.S. patent application Ser. No. 14/231,154, both of which are herein incorporated by reference in their entirety.

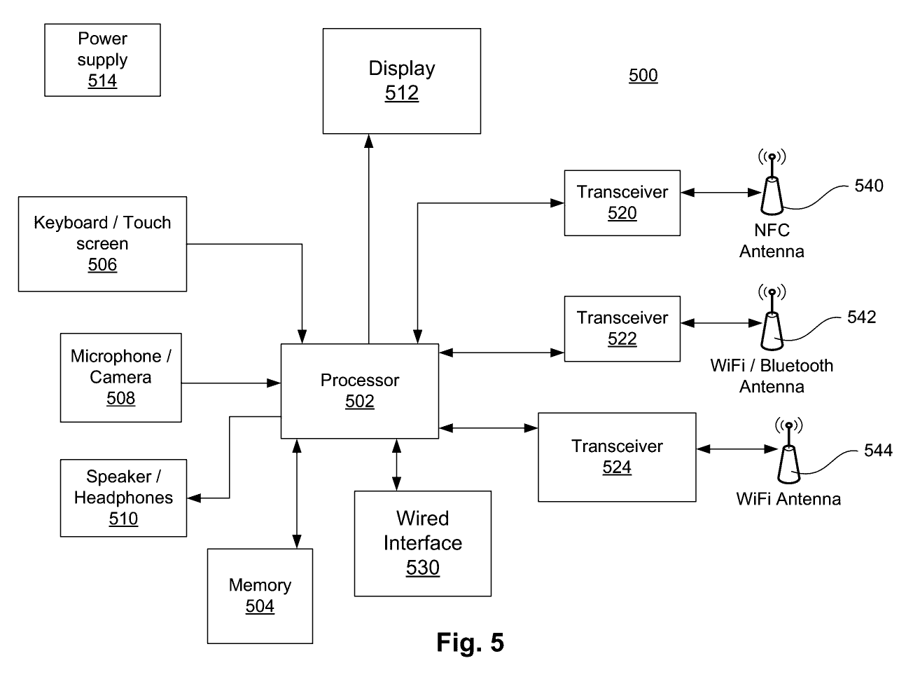

The components of an example mobile device 500 is further disclosed in FIG. 5 having a processor 502 executing instructions from volatile or non-volatile memory 504 and storing data thereto. The mobile device 500 has a number of human-computer interfaces such as a keypad or touch screen 506, a microphone and/or camera 508, a speaker or headphones 510, and a display 512, or any combinations thereof. The mobile device has a battery 514 supplying power to all the electronic components within the device. The battery 514 may be charged using wired or wireless charging.

The keyboard 506 could be a conventional keyboard found on most laptop computers or a soft-form keyboard constructed of flexible silicone material. The keyboard 506 could be a standard-sized 101-key or 104-key keyboard, a laptop-sized keyboard lacking a number pad, a handheld keyboard, a thumb-sized keyboard or a chorded keyboard known in the art. Alternatively, the mobile device 500 could have only a virtual keyboard displayed on the display 512 and uses a touch screen 506. The touch screen 506 can be any type of touch technology such as analog resistive, capacitive, projected capacitive, ultrasonic, infrared grid, camera-based (across touch surface, at the touch surface, away from the display, etc), in-cell optical, in-cell capacitive, in-cell resistive, electromagnetic, time-of-flight, frustrated total internal reflection (FTIR), diffused surface illumination, surface acoustic wave, bending wave touch, acoustic pulse recognition, force-sensing touch technology, or any other touch technology known in the art. The touch screen 506 could be a single touch or multi-touch screen. Alternatively, the microphone 508 may be used for input into the mobile device 500 using voice recognition.

The display 512 is typically small-size between the range of 1.5 inches to 14 inches to enable portability and has a resolution high enough to ensure readability of the display 512 at in-use distances. The display 512 could be a liquid crystal display (LCD) of any type, plasma, e-Ink®, projected, or any other display technology known in the art. If a touch screen 506 is present in the device, the display 512 is typically sized to be approximately the same size as the touch screen 506. The processor 502 generates a user interface for presentation on the display 512. The user controls the information displayed on the display 512 using either the touch screen or the keyboard 506 in conjunction with the user interface. Alternatively, the mobile device 500 may not have a display 512 and rely on sound through the speakers 510 or other display devices to present information.

The mobile device 500 has a number of network transceivers coupled to antennas for the processor to communicate with other devices. For example, the mobile device 500 may have a near-field communication (NFC) transceiver 520 and antenna 540; a WiFi®/Bluetooth® transceiver 522 and antenna 542; a cellular transceiver 524 and antenna 544 where at least one of the transceivers is a pairing transceiver used to pair devices. The mobile device 500 optionally also has a wired interface 530 such as USB or Ethernet connection.

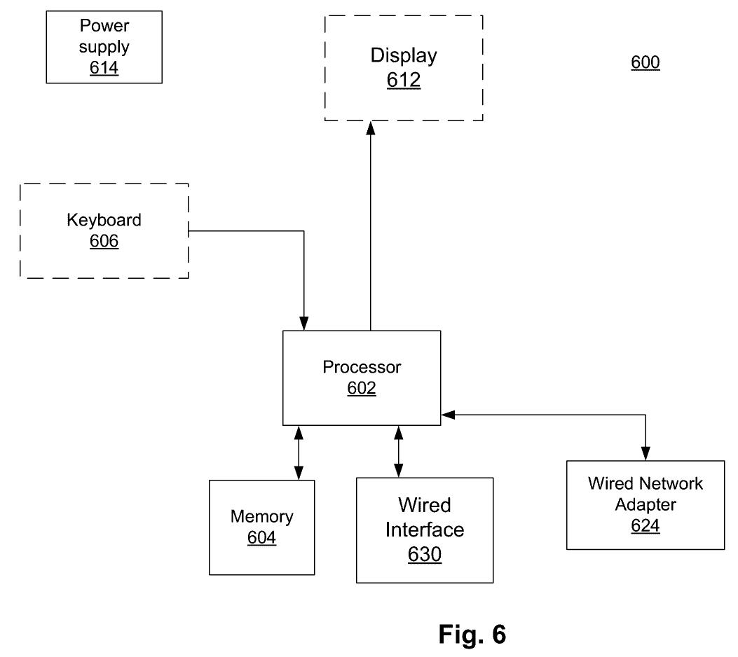

The servers 120, 122, 124 shown in FIG. 6 of the present embodiment have a similar structure to each other. The servers 120, 122, 124 have a processor 602 executing instructions from volatile or non-volatile memory 604 and storing data thereto. The servers 120, 122, 124 may or may not have a keyboard 306 and/or a display 312. The servers 120, 122, 124 communicate over the Internet 150 using the wired network adapter 624 to exchange information with the paired mobile device 105 and/or the capture board 108, conferencing, and sharing of captured content. The servers 120, 122, 124 may also have a wired interface 630 for connecting to backup storage devices or other type of peripheral known in the art. A wired power supply 614 supplies power to all of the electronic components of the servers 120, 122, 124.

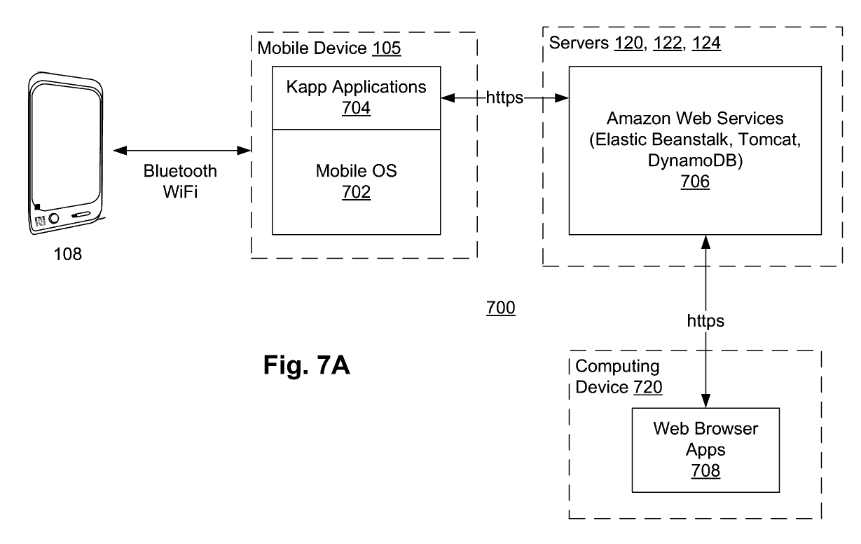

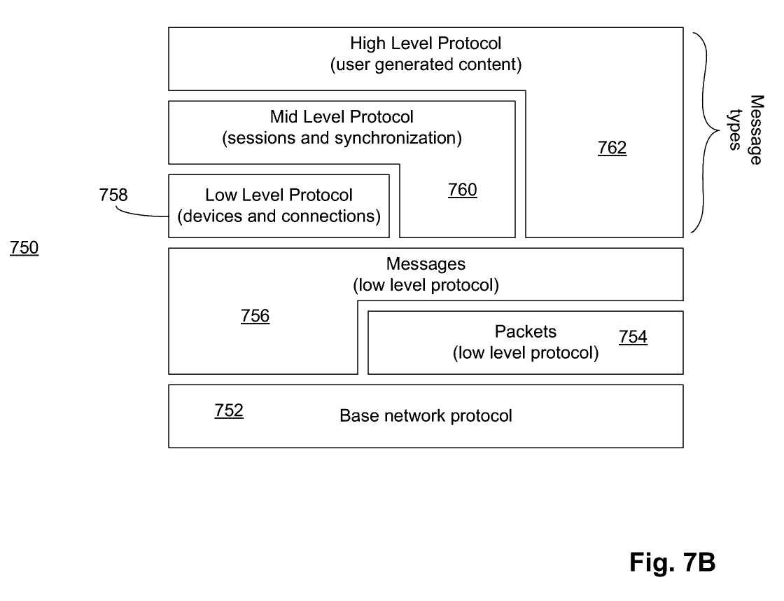

An overview of the system architecture 700 is presented in FIGS. 7A and 7B. The capture board 108 is paired with the mobile device 105 to create one or more wireless communications channels between the two devices. The mobile device 105 executes a mobile operating system (OS) 702 which generally manages the operation and hardware of the mobile device 105 and provides services for software applications 704 executing thereon. The software applications 704 communicate with the servers 120, 122, 124 executing a cloud-based execution and storage platform 706, such as for example Amazon Web Services, Elastic Beanstalk, Tomcat, DynamoDB, etc, using a secure hypertext transfer protocol (https). Any content stored on the cloud-based execution and storage platform 706 may be accessed using an HTML5-capable web browser application 708, such as Chrome, Internet Explorer, Firefox, etc, executing on a computer device 720. When the mobile device 105 connects to the capture board 108 and the servers 120, 122, 124, a session is generated as further described below. Each session has a unique session identifier.

FIG. 7B shows an example protocol stack 750 used by the devices connected to the session. The base network protocol layer 752 generally corresponds to the underlying communication protocol, such as for example, Bluetooth, WiFi Direct, WiFi, USB, Wireless USB, TCP/IP, UDP/IP, etc. and may vary based by the type of device. The packets layer 754 implement secure, in-order, reliable stream-oriented full-duplex communication when the base networking protocol 752 does not provide this functionality. The packets layer 754 may be optional depending on the underlying base network protocol layer 752. The messages layer 756 in particular handles all routing and communication of messages to the other devices in the session. The low level protocol layer 758 handles redirecting devices to other connections. The mid level protocol layer 760 handles the setup and synchronization of sessions. The High Level Protocol 762 handles messages relating the user generated content such as the template overlay 250 as further described herein below.

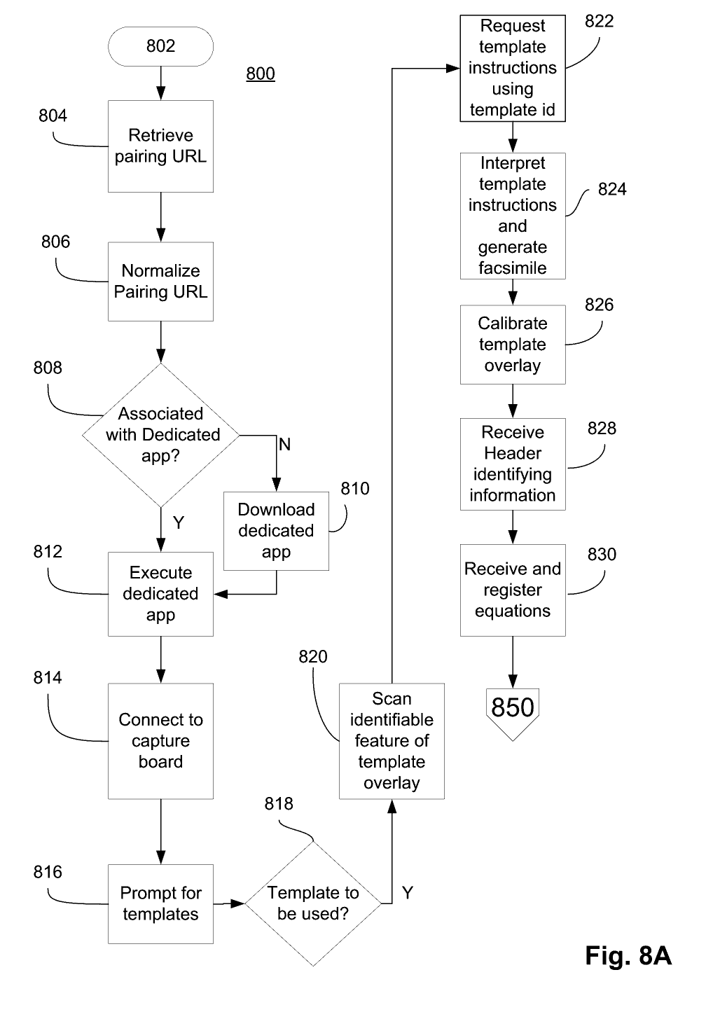

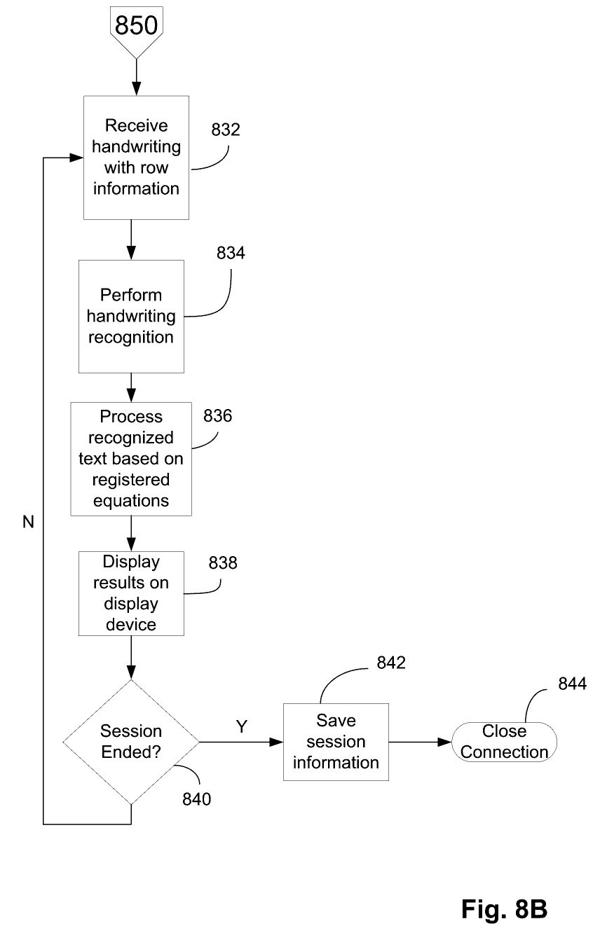

Turning now to FIGS. 8A and 8B, as previously mentioned uses a pairing URL for connection of the mobile device 105 to the capture board 108. Typically, a service executing on the mobile device 105 either scans the QR code 212 or NFC tag 214 which retrieves the pairing URL (step 804). Once retrieved, the pairing URL is normalized in order to extract the board ID portion (step 806).

If the pairing URL is not associated with any applications on the mobile device 105 (step 808), the pairing URL directs a browser executing on the mobile device 105 to a web site inviting the user to download a dedicated application for interfacing with the capture board 108 (step 810). If the dedicated application is already installed, the pairing URL will have been previously associated with the dedicated application (step 812). The operating system executing on the mobile device 105 initiates the dedicated application and passes the pairing URL thereto as an execution parameter. The dedicated application decodes the Bluetooth address (or other equivalent wireless address) based on the board ID and thereby optimizes the connection processes (step 814) as described in U.S. patent application Ser. No. 14/712,452, herein incorporated by reference.

Following connection, the dedicated application prompts the user of the mobile device 105 if there are any template overlays 250 to be used with the current session (step 816). If the user selects that a template overlay 250 is to be used (step 818), the dedicated application prompts the user to scan the identifiable feature 256 of the template overlay 250 (step 820). The reader such as a camera 508 or NFC scanner 520, 540 captures a template identifier of the template overlay 250. The mobile device 105 then submits a request for template overlay instructions for the template overlay from a template overlay database stored on the content server 124 (step 822). The template overlay instructions are interpreted by the dedicated application to generate a software facsimile of the template overlay 250 on the display 512 of the mobile device 105 (step 824).

If calibration is required, the dedicated application then prompts the user to contact the touch area 202 at two or more calibration points 258 of the template overlay 250 (step 826). These calibration points 258 are used to align the template overlay 250 with virtual template within the dedicated application. Alternatively, the calibration may be performed automatically using one or more cameras with fields of view encompassing the touch area 202.

The template overlay instructions may also divide the touch area 202 into defined input areas that may accept user input and ignore user input in areas outside of these defined areas. The user input into these defined input areas is recognized via text recognition (or shape recognition or other forms of graphical recognition) to identify at least one digitized input data. The template overlay instructions may also comprise pre-defined calculations to be performed on the at least one digitized input data to produce an output that may be displayed on the display 512 of the mobile device 105.

In some embodiments, once the template overlay 250 is identified, the user may enter header identifying information within the header fields 254; variables are defined in memory 504 for each header identifier (step 828). The user may then input equations using a tag such as “/eq” and use the header identifiers to operate on the data within the rows (step 830). Once the equation is registered by the dedicated application, the user may erase it from the capture board 108. The user may edit the equation within the dedicated application at a later time. Alternatively, the dedicated application may pass the equation to another application executing on the mobile device and the other application would interpret the equation content. When the user enters annotations within each row below the headers, the dedicated application receives the annotations with row information (step 832), performs handwriting recognition (step 834), and interprets the row information and processes the data based on the registered equations (step 836). When the user is complete, the session is ended (step 840) and saved (step 842). Otherwise, the processing continues to receive handwritten information (step 832). The connection between the mobile device 500 and the capture board 108 is then closed (step 844).

For example, the user may write the header identifiers of “A” and “B” in two columns and in a third column enter “/eq A+B” and a fourth column “/eq A*B”. When the dedicated application recognizes the equation (step 830), a notification is shown on the display 512 of the mobile device 105. The user may then erase the equations from the capture board 108 (not shown). When the user enters numbers in columns “A” and “B”, the dedicated application performed optical character recognition (OCR) or handwriting recognition (step 834) to convert the handwritten data into machine readable data and automatically calculate the third and fourth columns based on the registered equation (step 836) to generate the results for display (step 838). For capture boards 108 without a display 318, the calculated results are displayed only on the display 512 of the mobile device 105. The user may optionally specify the number of rows or set of rows that the equation applies by drawing a vertical line down to the last row in which the equation will apply. In another example, each of the fields corresponds to a respective field in an online database. The dedicated application may then upload the field data to the online database periodically or asynchronously.

In an alternative example, a calendar template overlay 250 is provided on the capture board 108. The user may specify in a month field, the current month and in the year field, the current year. Each day may then be numbered in a day field. Alternatively, only a week may be presented on the template overlay 250 for a manager to schedule a week in advance. In this example, the user may enter a tag such as “/user PCC phil@smarttech.com”. For any task written on the capture board 108 starting with PCC, the dedicated application assigns this task to the user PCC. Following the meeting, all tasks starting with PC are automatically emailed to the user's email address. Alternatively, the tasks may be entered automatically into the user's calendar on the specified dates.

Alternatively, a restaurant template overlay 250 is provided on the capture board 108. Tables may be assigned to particular pre-defined users using their initials such as PCC. The dedicated application may then notify the host or hostess when certain waiters have been assigned too few or too many tables in order to provide better service.

In another alternative example, the template overlay 250 may provide stock data to an inventory management system. The template overlay 250 comprises a store/warehouse identification field and a table of columns and rows for the user to enter stock data in such as SKU, units of stock, etc.

In yet another example with regard to a hospital environment, the template overlay 250 may comprise a list of patients on a ward present in the first column. The additional columns comprise vital signs such as blood pressure, heart rate, temperature, when the patient was last attended to, medication schedule, etc. The patient data input by the nurse or doctor may be retrieved from the capture board 108 and stored in a patient database according to a patient identifier.

In yet another example with regard to a customer service department, a return merchandize authorization (RMA) list may be provided by the template overlay 250. As the

RMA data is entered onto the capture board 108, the headquarters enterprise resource management system (ERP) may retrieve the RMA data periodically or asynchronously. The RMA data may then be used by the ERP system in order to identify product design faults, etc.

In another example in a classroom setting, the template overlay 250 may comprise a list of students in the classroom and an attendance field for each student on the list. The teacher may then enter whether the student is present or not. The school office may then retrieve the attendance data and store it in the board of education server system. The template over lay 250 may further comprise the location of the student and a place for the teacher to initial to confirm the attendance is complete. The teacher's initials may be confirmed using biometric data to confirm that the actual teacher input the attendance information.

The template overlays 250 may be authored by a user to generate customized forms and/or templates for the capture board 108. When complete the template overlay instructions may be uploaded to the user's account on the content server 124 and a unique QR code corresponding to the template identifier that may be automatically generated based on the template overlay instructions and/or portions of the template overlay 250. Optionally, the template overlay 250 and template overlay instructions may be uploaded to a manufacturer on approval and payment of the user. The manufacturer may then print out the template overlay 250 using a plotter or other suitable printing device (not shown) such as an inkjet printer or laser printer. The template overlay 250 may be printed in sections.

Also optionally, the user may choose to share the template overlay 250 and instructions with a community online.

In alternative examples where the capture board 108 has a display 318, the template overlay 250 may be virtual and displayed by the display 318 on the capture board 108. In such a system, the user may select a virtual template overlay 250 on the display 318 and the capture board 108 may notify devices connected to the session of the template identifier. Alternatively, the user may select the template overlay 250 on the mobile device 105. The capture board 108 may optimize the display of the template overlay 250 using the processing structure 302.

In another alternative example, other forms of displaying the template overlay 250 on the capture board 108 may be employed such as using laser or light beams, a projector, or forms of electronic ink or LCD display.

In yet another alternative example, the user may enter a template generation mode where the user may enter template content where text is automatically recognized using a text recognition engine and the user may denote fields using field identifiers using eXtensible Markup Language (XML) or other type of markup language. The XML, field identifiers then become hidden from view when the template generation mode is exited. The user may then use the field identifiers to perform operations on the form date (e.g. “/eq%FieldA%+%FieldB”).

Although the examples described herein show all of the fields on the capture board 108, the inventor contemplates that the dedicated application may not display all of the fields and may calculate results based on the displayed fields and store them in memory 504 of the mobile device 105.

Although the embodiments described herein refer to a pen, the inventor contemplates that the pointer may be any type of pointing device such as a dry erase marker, ballpoint pen, ruler, pencil, finger, thumb, or any other generally elongate member. Preferably, these pen-type devices have one or more ends configured of a material as to not damage the display 318 or touch area 202 when coming into contact therewith under in-use forces.

In an alternative embodiment, the control bar 210 may comprise a template button enabling the capture board 108 to easily enter or exit template generation mode. When in template mode, the template button may be illuminated.

Although the embodiments described herein perform recognition of handwriting on the mobile device, other embodiments may perform the recognition on the interactive device and relay the recognized text to the mobile device.

Although the embodiments described herein recite that the template instructions are transmitted to the mobile device, other embodiments may have the template instructions transmitted to the interactive device. In such embodiments, the calculations or processing of the labeled user input may likewise be performed on the interactive device.

Although the embodiments described herein have the content server providing the template instructions, other embodiments may have the content server within the interactive device or may be one in the same as the interactive device.

The emitters and detectors may be narrower or wider, narrower angle or wider angle, various wavelengths, various powers, coherent or not, etc. As another example, different types of multiplexing may be used to allow light from multiple emitters to be received by each detector. In another alternative, the FPGA 302 may modulate the light emitted by the emitters to enable multiple emitters to be active at once.

The touch screen 306 can be any type of touch technology such as analog resistive, capacitive, projected capacitive, ultrasonic, infrared grid, camera-based (across touch surface, at the touch surface, away from the display, etc), in-cell optical, in-cell capacitive, in-cell resistive, electromagnetic, time-of-flight, frustrated total internal reflection (FTIR), diffused surface illumination, surface acoustic wave, bending wave touch, acoustic pulse recognition, force-sensing touch technology, or any other touch technology known in the art. The touch screen 306 could be a single touch, a multi-touch screen, or a multi-user, multi-touch screen.

Although the mobile device 200 is described as a smartphone 102, tablet 104, or laptop 106, in alternative embodiments, the mobile device 105 may be built into a conventional pen, a card-like device similar to an RFID card, a camera, or other portable device.

Although the servers 120, 122, 124 are described herein as discrete servers, other combinations may be possible. For example, the three servers may be incorporated into a single server, or there may be a plurality of each type of server in order to balance the server load.

These interactive input systems include but are not limited to: touch systems comprising touch panels employing analog resistive or machine vision technology to register pointer input such as those disclosed in U.S. Pat. Nos. 5,448,263; 6,141,000; 6,337,681; 6,747,636; 6,803,906; 7,232,986; 7,236,162; 7,274,356; and 7,532,206 assigned to SMART Technologies ULC of Calgary, Alberta, Canada, assignee of the subject application, the entire disclosures of which are incorporated by reference; touch systems comprising touch panels or tables employing electromagnetic, capacitive, acoustic or other technologies to register pointer input; laptop and tablet personal computers (PCs); smartphones, personal digital assistants (PDAs) and other handheld devices; and other similar devices.

Although the embodiments described herein determine the template overlay 250 using NFC or QR code, the inventor contemplates that other means of identifying the template overlay 250 are possible such as general communication between the devices, such as, but not limited to, WiFi, Bluetooth, WiFi Direct, LTE, 3G, wired Ethernet, Infrared, 1-dimensional bar code, etc.

Although the examples described herein are in reference to a capture board 108, the inventor contemplates that the features and concepts may apply equally well to other collaborative devices 107 such as the interactive flat screen display 110, interactive whiteboard 112, the interactive table 114, or other type of interactive device. Each type of collaborative device 107 may have the same protocol level or different protocol levels.

The above-described embodiments are intended to be examples of the present invention and alterations and modifications may be effected thereto, by those of skill in the art, without departing from the scope of the invention, which is defined solely by the claims appended hereto.

What is claimed is:

1. A mobile device comprising:
a processing structure;
a reader coupled to the processing structure;
a network communicating with the processing structure and a content server; and
a computer-readable medium coupled to the processing structure, the computer-readable medium comprising instructions to configure the processing structure to:
scan, using the reader, an identifiable feature of a template overlay;
interpret the identifiable feature to produce a template identifier;
request template overlay instructions associated with the template identifier from the content server;
receive the template overlay instructions from the content server over the network;
upon receiving input from an interactive device into an area of the template overlay displayed over an interactive surface of the interactive device;
recognizing, via text recognition, the input into the area to identify at least one digitized input data;
identifying a subset of the template overlay instructions associated with the area; and
automatically executing the subset of the template overlay instructions.

2. The mobile device according to claim 1, wherein the template overlay instructions define at least one label region of the template overlay; upon receiving input from the interactive device within the at least one label region, recognizing, via text recognition, at least one label.

3. The mobile device according to claim 2, wherein the template overlay instructions associate at least a portion of the area with at least one equation; the at least one equation using at least one of the labels.

4. The mobile device according to claim 1, wherein the template overlay is selected from at least one of a virtual overlay or a physical overlay.

5. The mobile device according to claim 1, further comprising:
a local network communicating with the processing structure and an interactive device; and instructions to configure the processing structure to:
prompt a user to contact the template overlay on at least two calibration points; and
align the template overlay with a virtual template.

6. The mobile device according to claim 1, wherein the reader comprises a camera.

7. The mobile device according to claim 1, wherein the reader comprises a near-field communication (NFC) scanner.

8. The mobile device according to claim 1 further comprising instructions to configure the processing structure to:
receive a set of rows following receiving the at least one equation; and
automatically executing the equation on labeled input entered into the set of rows.

9. The mobile device according to claim 1 wherein the labeled input is aligned in a column below the at least one label.

10. The mobile device according to claim 1, wherein modification of the at least one equation initiates re-executing the equation on the labeled input.

11. The mobile device according to claim 6, wherein the identifiable feature comprises a 2-D barcode.

12. The mobile device according to claim 7, wherein the identifiable feature comprises a NFC tag.

13. An interactive device comprising:
a processing structure;
an interactive surface;
a template overlay generally aligned with the interactive surface;
an identifiable feature associated with the template overlay;
a transceiver communicating with a mobile device over a network using a communication protocol; and
a computer-readable medium, coupled to the processing structure, comprising instructions to configure the processing structure to:
determine a location of a pointer on the interactive surface;
transmit the location of the pointer to the mobile device over the network;
receive a template identifier from the mobile device;
in response to the template identifier, retrieve template overlay instructions associated with the template identifier from a content server; and
relaying the template overlay instructions to the mobile device.

14. The interactive device according to claim 13, further comprising instructions to:
recognize, via text recognition, input into an area on the interactive surface defined by the template overlay instructions to identify at least one digitized input data.

15. The interactive device according to claim 14, wherein the template overlay instructions associate the area with at least one equation; the at least one equation using at least one of the labels.

16. The interactive device according to claim 15 further comprising instructions to configure the processing structure to:
receive a set of rows following receiving the at least one equation; and
automatically executing the equation on labeled input entered into the set of rows.

17. The interactive device according to claim 16 wherein the labeled input is aligned in a column below the at least one label.

18. The mobile device according to claim 16, wherein modification of the at least one equation initiates re-executing the equation on the labeled input.

19. The interactive device according to claim 13, wherein the identifiable feature comprises at least one of a 2-D barcode and a NFC tag.

20. The interactive device according to claim 13, wherein the template overlay is selected from at least one of a virtual overlay or a physical overlay.
